(19) United States
(12) Patent Application Publication
(10) Pub. No.: US 2012/0007473 A1
(43) Pub. Date: Jan. 12, 2012

(54) PIEZOELECTRIC GENERATOR UNIT USING PIEZOELECTRIC BIMORPH

(75) Inventor: Jeong Hwan OH, Daejeon (KR)

(73) Assignee: PEOPLE & ENVIRONMENT CO., LTD., Daejeon (KR)

(21) Appl. No.: 13/142,119

(22) PCT Filed: Feb. 25, 2010
(86) PCT No.: PCT/KR10/01203

§ 371 Date: Jun. 24, 2011

(51) Int. Cl. H02N 2/18

(52) U.S. Cl. 310/339

(57) ABSTRACT

Disclosed herein is a piezoelectric generator unit using a piezoelectric bimorph. The piezoelectric generator unit includes a cylindrical housing, a fly wheel rotated within the housing by external power and provided with plural protrusions arranged at a regular interval in the circumferential direction, a fluid ejection device transmitting power to the fly wheel by ejecting a fluid or air onto impellers of the fly wheel to rotate the fly wheel, plural piezoelectric members installed radially and contacting the plural protrusions to generate electricity due to impact, and a central shaft connected to the plural piezoelectric members via connection members. The piezoelectric generator unit effectively converts a linear motion into a rotary motion simply using slight impact or vibration so as to effectively generate electrical energy, generates high output at low input so as to improve power generation efficiency, and is applicable to various fields using a moving load.

### BACKGROUND OF THE INVENTION

1. Field of the Invention

The present invention relates to a piezoelectric generator unit, and more particularly to a piezoelectric generator unit using a piezoelectric bimorph which converts a linear motion into a rotary motion using simple pressure obtained due to walking or a moving load of a vehicle or load pressure obtained due to vibration so as to more effectively generate electrical energy.

2. Description of the Related Art

In general, piezoelectric materials are used as converters to convert mechanical energy into electrical energy and are applied to various fields. A large number of materials including inorganic materials and organic materials are known as materials to exhibit piezoelectric characteristics.

A piezoelectric element is a device which generates voltage by means of force applied thereto and changes an intensity of voltage generated according to intensity of the applied force.

When a piezoelectric generator using such a piezoelectric element is manufactured, it is important to effectively transmit external impact or vibration to the piezoelectric element without loss.

Further, since, if excessive impact is transmitted to the piezoelectric element, the piezoelectric element may be damaged, a structure to prevent excessive impact from being transmitted to the piezoelectric element while effectively transmitting external mechanical energy to the piezoelectric element is required.

Particularly, a piezoelectric element formed of ceramic has high brittleness and thus requires a housing to prevent damage to the piezoelectric element due to excessive external force while effectively transmitting mechanical energy to the piezoelectric element.

In order to enable the piezoelectric element to convert mechanical energy transmitted from the outside into electrical energy, the piezoelectric element needs to be electrically connected to an external circuit through an electrode attached to the piezoelectric element or connected to the piezoelectric element.

However, when continuous vibration and impact are transmitted to the piezoelectric element used in the piezoelectric generator, electrical connection between the piezoelectric element and the electrode is severed. Therefore, a generator unit, which maintains electrical connection between the piezoelectric element and the electrode in spite of such vibration and impact, or a system of the generator unit needs to be developed, but does not obtain satisfactory results so far.

### SUMMARY OF THE INVENTION

Therefore, the present invention has been made in view of the above problems, and it is an object of the present invention to provide a piezoelectric generator unit using a piezoelectric bimorph which converts a linear motion into a rotary motion using simple pressure obtained due to walking or a moving load of a vehicle or load pressure obtained due to vibration so as to more effectively generate electrical energy.

In accordance with an aspect of the present invention, the above and other objects can be accomplished by the provision of a piezoelectric generator unit using a piezoelectric bimorph including a cylindrical housing, a fly wheel rotated within the housing by external power and provided with a plurality of protrusions formed at the inside thereof and arranged at a regular interval in the circumferential direction, a fluid ejection device transmitting power to the fly wheel by ejecting a fluid or air onto impellers of the fly wheel to rotate the fly wheel, a plurality of piezoelectric members installed radially and contacting the plurality of protrusions of the fly wheel to generate electricity due to impact caused by the contact, and a central shaft connected to the plurality of piezoelectric members via connection members.

The housing may be provided with a fluid injection passage and a fluid discharge passage, formed on the outer surface thereof, so as to supply the fluid to the fly wheel.

The fluid ejection device may include a fluid pump to eject the fluid.

The connection members connected to the plurality of piezoelectric members may be formed of an elastic body so as to enable the plurality of piezoelectric members to have elastic restoring force

In accordance with another aspect of the present invention, there is provided a piezoelectric generator unit using a piezoelectric bimorph including a housing including a cover and a ring, rotated by external force and provided with a plurality of protrusions formed at the inside thereof and arranged at a regular interval in the circumferential direction, a drive unit mechanically transmitting power to the housing to rotate the housing, a plurality of piezoelectric members installed radially and contacting the plurality of protrusions of the housing to generate electricity due to impact caused by the contact, and a central shaft connected to the plurality of piezoelectric members via connection members.

The drive unit may include a rack gear moving linearly, a pinion engaged with the rack gear to convert a linear motion into a rotary motion, and a driving gear engaged with a connection gear connected to the pinion, rotated by rotary force of the pinion and assembled with the housing to rotate the housing.

The plurality of piezoelectric members may include ceramic piezoelectric members and polymer piezoelectric members, and the ceramic piezoelectric members and the polymer piezoelectric members may be alternately installed.

Hitting protrusions may be formed on plate surfaces of the polymer piezoelectric members so as to hit the ceramic piezoelectric members.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view illustrating a piezoelectric generator unit using a piezoelectric bimorph in accordance with one embodiment of the present invention;

FIG. 2 is a perspective view illustrating a rear surface part of the piezoelectric generator unit of FIG. 1;

FIG. 3 is an exploded perspective view of the configuration of the piezoelectric generator unit in accordance with the embodiment of the present invention;

FIG. 4 is a perspective view illustrating a state in which one example of a drive unit is applied to a piezoelectric generator unit in accordance with another embodiment of the present invention;

FIG. 5 is a perspective view illustrating a rear surface part of the piezoelectric generator unit of FIG. 4;

FIG. 6 is an exploded perspective view of the drive unit of the piezoelectric generator unit in accordance with the embodiment of the present invention; and

FIG. 7 is a view illustrating a driving state of the piezoelectric generator unit in accordance with the embodiment of the present invention.

### DETAILED DESCRIPTION OF THE INVENTION

Hereinafter, preferred embodiments of the present invention will be described in detail with reference to the annexed drawings so that those skilled in the art may easily embody the present invention. However, the present invention is not limited to the embodiments and the embodiments may be variously modified.

Specific terms used in the following description are given only to describe specific embodiments and are not intended to limit the present invention. Singular forms used in the following description include plural forms unless they apparently represent opposite meanings. The meaning of “including” used in the following description is intended to embody specific properties, regions, integers, steps, operations, elements and/or components, but is not intended to exclude presence or addition of other properties, regions, integers, steps, operations, elements, components and/or groups.

Although not defined differently, all terms including technical terms and scientific terms used in the following description have the same meanings as meanings understood by those skilled in the art. Terms generally defined in dictionaries are interpreted as having meanings coinciding with those disclosed in related documents and the following description, but are not interpreted as having ideal and official meanings unless they are defined as such.

The embodiments of the present invention described with reference to perspective views concretely represent ideal embodiments of the present invention. Consequently, it will be expected that various modifications of the embodiments, for example, modifications of a manufacturing method and/or specifications, are possible. Therefore, the embodiments are not limited to specific forms of illustrated regions, and, for example, modifications of the forms due to manufacture may be possible. For example, a region illustrated or described as being flat may be rough or rough and nonlinear. Further, a part illustrated as being sharpened at a designated angle may be rounded. Therefore, the regions illustrated in the drawings are only schematically illustrated, but the forms thereof are not intended to illustrate accurate shapes thereof and to narrow the scope of the present invention.

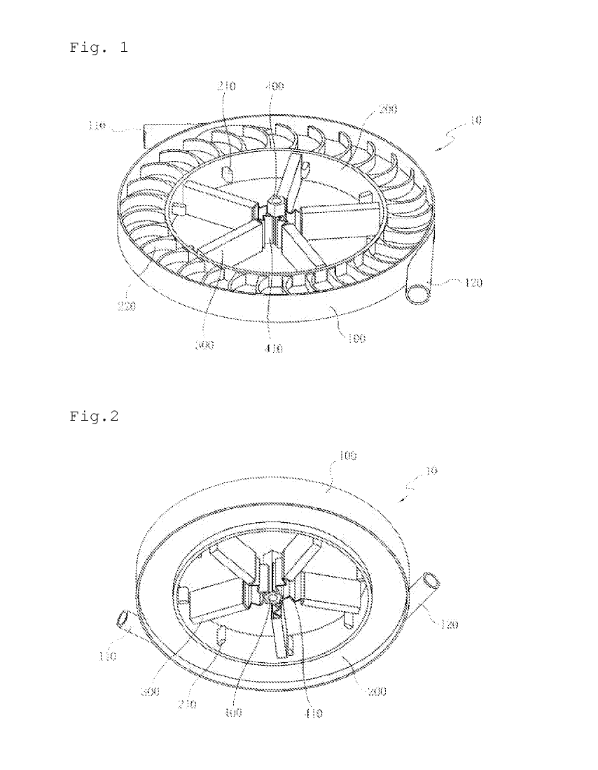

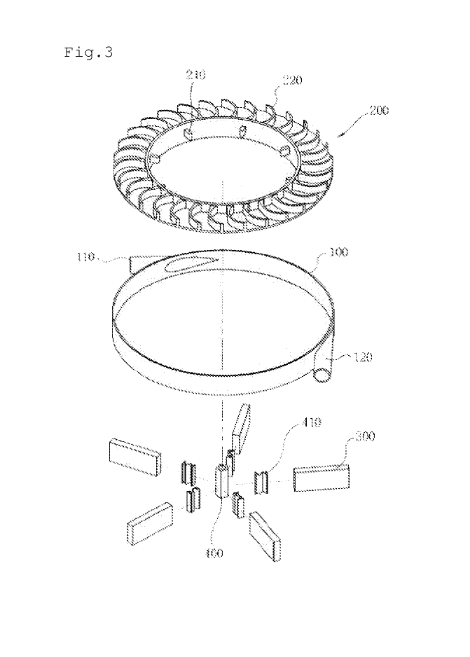

Hereinafter, with reference to FIGS. 1 to 3, a piezoelectric generator unit using a piezoelectric bimorph in accordance with one embodiment of the present invention will be described. A piezoelectric generator unit 10 in accordance with this embodiment generally includes a housing 100, a fly wheel 200, a fluid ejection device, piezoelectric members 300 and a central shaft 400.

The housing 100 is formed in a cylindrical shape so as to supply a fluid to the fly wheel 200 while accommodating the fly wheel 200.

The housing 100 is provided with a fluid injection passage 110 and a fluid discharge passage 120 formed on the outer surface thereof, thus supplying the fluid to the fly wheel 200.

The fly wheel 200 is rotated within the housing 100 by external power and is provided with a plurality of protrusions 210 formed at the inside thereof and arranged at a regular interval in the circumferential direction. The fluid is ejected onto a plurality of impellers 220 installed within the fly wheel 200, and thus the fly wheel 200 is rotated to generate electric energy.

The fluid ejection device ejects the fluid onto the impellers 220 of the fly wheel 200 so as to transmit power, thus rotating the fly wheel 200. The fluid ejection device is configured such that the fluid supplied to the fly wheel 200 is pressurized by a pump and is then ejected onto the fly wheel 200 through a nozzle.

The fluid ejection device includes a fluid pump to eject the fluid.

The piezoelectric members 300 serve to generate electricity due to impact caused by contact with the protrusions 210 of the fly wheel 200. The plural piezoelectric members 300 are radially installed on the inner surface of the fly wheel 200.

The piezoelectric members 300 may be generally formed of various piezoelectric layers, such as Pb(Zr,Ti)O₃, Pb(Zr,Ti)O₃+Pb(Ni,Nb)O₃, Pb(Zr,Ti)O₃+a PVDF polymer, Pb(Zr,Ti)O₃+a silicon polymer, Pb(Zr,Ti)O₃+an epoxy polymer and LiTaO₃. That is, the piezoelectric members 300 may be formed of at least one selected from among the above-described piezoelectric layers.

The central shaft 400 is connected to the piezoelectric members 300 via connection members 410, and the piezoelectric members 300 are radially installed around the central shaft 400.

The connection members 410 connected to the piezoelectric members 300 are formed of an elastic body, thus enabling the piezoelectric members 300 to have elastic restoring force.

Here, the number of the piezoelectric members 300 of the piezoelectric generator unit 10 having the above structure may be increased or decreased corresponding to generative power, and the piezoelectric generator unit 10 may effectively convert a linear motion into a rotary motion using impact or vibration applied to the piezoelectric members 300.

Further, an operating structure of the piezoelectric generator unit 10 will be described below. First, when a fluid or air is injected into the housing 100 through the fluid injection passage 110 of the housing 100, the fluid collides with the impellers 220 of the fly wheel 200 and thus rotates the fly wheel 200, and the protrusions 210 formed at the inside of the fly wheel 200 collide with the piezoelectric members 300 according to rotation of the fly wheel 200 and thus apply impact to the piezoelectric members 300, thereby generating electrical energy.

Impact is applied to the piezoelectric members 300 by rotation of the fly wheel 200 and thus power loss due to transmission of rotational force may be reduced.

Further, the fluid supplied to the fly wheel 200 is discharged to the outside through the fluid discharge passage 120 of the housing 100 so that a fluid is newly supplied to the housing 100 through the fluid injection passage 110, thereby circulating the fluid and thus enabling the piezoelectric generator unit 10 to be continuously operated.

Therefore, the piezoelectric generator unit 10, which converts a linear motion into a rotary motion to generate electrical energy, pumps out the fluid in the fluid pump of the fluid ejection device and ejects the fluid onto the impellers 220 of the fly wheel 200 to rotate the fly wheel 200. Thereby, the piezoelectric generator unit 10 applies continuous and concurrent impact to the piezoelectric members 300, thus obtaining continuous electrical output.

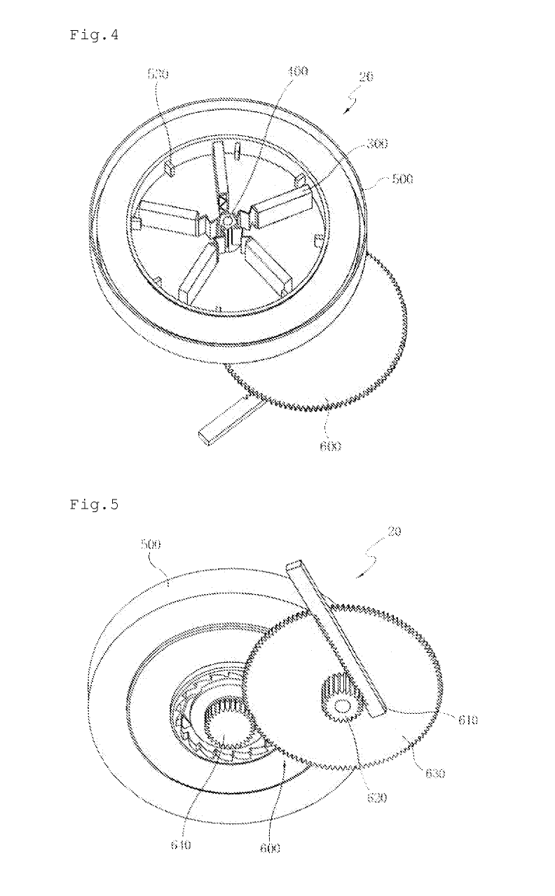

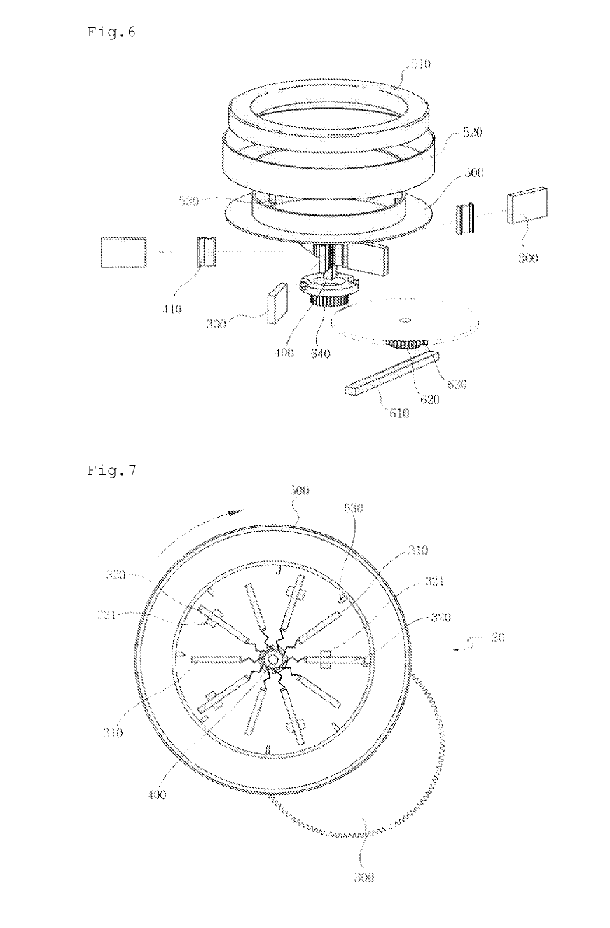

Hereinafter, with reference to FIGS. 4 to 6, a piezoelectric generator unit using a piezoelectric bimorph in accordance with another embodiment of the present invention will be described. A piezoelectric generator unit 20 in accordance with this embodiment generally includes a housing 500, a drive unit 600, piezoelectric members 300 and a central shaft 400.

The housing 500 includes a cover 510 and a ring 520 and is rotated by external power. The housing 500 is provided with a plurality of protrusions 530 formed at the inside thereof and arranged at a regular interval in the circumferential direction.

The drive unit 600 serves to mechanically transmit power to the housing 500 to rotate the housing 500. The drive unit 600 includes a rack gear 610 moving linearly, a pinion 620 engaged with the rack gear 610 to convert a linear motion into a rotary motion, and a driving gear 640 engaged with a connection gear 630 connected to the pinion 620, rotated by rotary force of the pinion 620 and assembled with the housing 500 to rotate the housing 500.

The plural piezoelectric members 300 serve to generate electricity due to impact caused by contact with the protrusions 530 of the housing 500 and are radially installed. The piezoelectric members 300 include ceramic piezoelectric members 310 and polymer piezoelectric members 320, and the ceramic piezoelectric members 310 and the polymer piezoelectric members 320 are alternately installed.

Further, hitting protrusions 321 are formed on plate surfaces of the polymer piezoelectric members 320 so as to hit the ceramic piezoelectric members 310.

The reason why the hitting protrusions 321 are installed on only the polymer piezoelectric members 320 is to use elasticity of the polymer piezoelectric members 320. Since the ceramic piezoelectric members 310 do not have elasticity due to brittleness thereof, a hit is applied to the ceramic piezoelectric members 310 in a fixed state, thereby generating voltage.

The central shaft 400 is connected to the piezoelectric members 300 via connection members 410, and the piezoelectric members 300 are radially installed around the central shaft 400.

The connection members 410 connected to the piezoelectric members 300 are formed of an elastic body, thus enabling the piezoelectric members 300 to have elastic restoring force.

Here, the number of the ceramic piezoelectric members 310 or the polymer piezoelectric members 320 of the piezoelectric members 300 of the piezoelectric generator unit 20 having the above structure may be increased and decreased corresponding to generative power, and the piezoelectric generator unit 20 may effectively convert a linear motion into a rotary motion using impact or vibration applied to the piezoelectric members 300.

That is, the piezoelectric generator unit 20 applies continuous and concurrent impact to the ceramic piezoelectric members 310 and the polymer piezoelectric members 320 by rotation of the housing 500, thus obtaining continuous electrical output.

Further, the drive unit 600 to rotate the housing 500 converts a linear motion of the rack gear 610 into a rotary motion through the pinion 620 and transmits the rotary motion of the pinion 620 to the driving gear 640 assembled with the housing 500 through the connection gear 630, thereby rotating the housing 500 using rotation of the driving gear 640.

Now, an operating structure of the piezoelectric generator unit 20 will be described below with reference to FIG. 7. First, when the housing 500 is rotated by the drive unit 600, the protrusions 530 formed on the housing 500 hit the polymer piezoelectric members 320 and chain collision is applied to the ceramic piezoelectric members 310 due to rebound of the polymer piezoelectric members 320. That is, chain collision is applied to the ceramic piezoelectric members 310 due to impact transfer, thereby enabling the piezoelectric generator unit 20 to generate high voltage.

Therefore, the piezoelectric generator units 10 and 20 in accordance with the embodiments of the present invention, which convert a linear motion into a rotary motion to generate electrical energy, continuously maintain high rotary force of a rotary body, such as the housing 500, thereby inducing continuous power generation.

Further, the piezoelectric generator units 10 and 20 apply impact to the piezoelectric members 300 using rotary force of a micro motor, if a high intensity of output at small energy within a small space is required, thereby inducing output power greatly higher than input power.

As apparent from the above description, the piezoelectric generator unit in accordance with one embodiment of the present invention converts a linear motion into a rotary motion simply using slight impact or vibration and thus may effectively generate electrical energy. Further, the piezoelectric generator unit generates high output at low input and thus may improve power generation efficiency, and may be applied to various fields using a moving load.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A piezoelectric generator unit using a piezoelectric bimorph comprising:
a cylindrical housing;
a fly wheel rotated within the housing by external power and provided with a plurality of protrusions formed at the inside thereof and arranged at a regular interval in the circumferential direction;
a fluid ejection device transmitting power to the fly wheel by ejecting a fluid or air onto impellers of the fly wheel to rotate the fly wheel;
a plurality of piezoelectric members installed radially and contacting the plurality of protrusions of the fly wheel to generate electricity due to impact caused by the contact; and
a central shaft connected to the plurality of piezoelectric members via connection members.

2. The piezoelectric generator unit according to claim 1, wherein the housing is provided with a fluid injection passage and a fluid discharge passage, formed on the outer surface thereof, so as to supply the fluid to the fly wheel.

3. The piezoelectric generator unit according to claim 1, wherein the fluid ejection device includes a fluid pump to eject the fluid.

4. The piezoelectric generator unit according to claim 1, wherein the connection members connected to the plurality of piezoelectric members are formed of an elastic body so as to enable the plurality of piezoelectric members to have elastic restoring force

5. A piezoelectric generator unit using a piezoelectric bimorph comprising:
a housing including a cover and a ring, rotated by external force and provided with a plurality of protrusions formed at the inside thereof and arranged at a regular interval in the circumferential direction;
a drive unit mechanically transmitting power to the housing to rotate the housing;
a plurality of piezoelectric members installed radially and contacting the plurality of protrusions of the housing to generate electricity due to impact caused by the contact; and
a central shaft connected to the plurality of piezoelectric members via connection members.

6. The piezoelectric generator unit according to claim 5, wherein the drive unit includes a rack gear moving linearly, a pinion engaged with the rack gear to convert a linear motion into a rotary motion, and a driving gear engaged with a connection gear connected to the pinion, rotated by rotary force of the pinion and assembled with the housing to rotate the housing.

7. The piezoelectric generator unit according to claim 5, wherein the plurality of piezoelectric members includes ceramic piezoelectric members and polymer piezoelectric members, and the ceramic piezoelectric members and the polymer piezoelectric members are alternately installed.

8. The piezoelectric generator unit according to claim 7, wherein hitting protrusions are formed on plate surfaces of the polymer piezoelectric members so as to hit the ceramic piezoelectric members.
